(19) United States
(12) Patent Application Publication
(10) Pub. No.: US 2015/0253897 A1
(43) Pub. Date: Sep. 10, 2015

(54) BONDING PAD STRUCTURE AND TOUCH PANEL

(71) Applicant: Wistron Corporation, New Taipei City (TW)

(72) Inventors: Ray Liang, New Taipei City (TW); Zheng-Xiang Liu, New Taipei City (TW); Fei Teng, New Taipei City (TW)

(21) Appl. No.: 14/312,693

(22) Filed: Jun. 24, 2014

(30) Foreign Application Priority Data
Mar. 5, 2014 (CN) 201410079596.9

(51) Int. Cl. G06F 3/044; G06F 1/16; H01B 5/00

(52) U.S. Cl. CPC G06F 3/044; H01B 5/00; G06F 1/16

(57) ABSTRACT

A bonding pad structure including a first sub-bonding pad and a second sub-bonding pad and a touch panel are provided. The first sub-bonding pad has a first connection terminal at an opposite side of a first end terminal. A width of the first connection terminal is greater than a width of the first end terminal. The first sub-bonding pad has a second connection terminal at an opposite side of a second end terminal. A width of the second connection terminal is greater than a width of the second end terminal. The first connection terminal is close to the second end terminal and the second connection terminal is close to the first end terminal. A first outline of the first sub-bonding pad and a second outline of the second sub-bonding pad are formed as a pair in a complementary manner to construct a configuration of the bonding pad structure.

### CROSS-REFERENCE TO RELATED APPLICATION

This application claims the priority benefit of China application serial no. 201410079596.9, filed on Mar. 5, 2014. The entirety of the above-mentioned patent application is hereby incorporated by reference herein and made a part of this specification.

### BACKGROUND OF THE INVENTION

1. Field of the Invention

The invention is related to a touch sensing device and a bonding structure thereof, and more particularly to a touch panel and a bonding pad structure thereof.

2. Description of Related Art

Touch panels are roughly grouped into resistive touch panels, capacitive touch panels, optical touch panels, acoustic wave touch panels and electromagnetic touch panels according to different sensing principles thereof. The capacitive touch panel is characterized by short response speed, favorable reliability, satisfactory durability, and so on. Therefore, the capacitive touch panel is widely used in the electronic products. Moreover, the capacitive touch panels may be roughly categorized into self capacitance (self-type) touch panels or mutual capacitance (mutual-type) touch panels according to different capacitance sensing principles.

Take the mutual capacitance touch panels (mutual-type) as an example, the touch panel includes a plurality of first axial (such as X axis) sensing patterns and a plurality of second axial (such as Y axis) sensing patterns. The first axial sensing patterns and the second axial sensing patterns are alternately disposed with independent signals. With such design, the first axial sensing patterns and the second axial sensing patterns need to be respectively electrically connected to a plurality of bonding pads that are collectively disposed in parallel at one side of the substrate where the first axis sensing patterns and/or the second axis sensing patterns are located. Moreover, to realize the requirement of electrical properties and tests, even the both ends of some sensing patterns with the same axis need to be connected to different bonding pads. Consequently, the number of disposed bonding pads increases, causing it difficult to reduce the area required for the circuit board to be bonded to the bonding pad and the bonding medium (such as conductive adhesive), which further makes it difficult to reduce the cost of the capacitance touch panels.

### SUMMARY OF THE INVENTION

The invention provides a touch panel, and the configuration and layout thereof provide ideal space utilization.

The invention provides a touch panel, and the configuration and layout of the bonding pad in the touch panel provide ideal space utilization that facilitates to ensure test accuracy.

In the invention, a bonding pad structure includes a first sub-bonding pad and a second sub-bonding pad. The first sub-bonding pad has a first connection terminal and a first end terminal respectively located at two opposite ends, wherein a width of the first connection terminal is greater than a width of the first end terminal. The first sub-bonding pad is close to but separated from the second sub-bonding pad. The second sub-bonding pad has a second connection terminal and a second end terminal respectively located at two opposite ends, wherein a width of the second connection terminal is greater than a width of the second end terminal. The first connection terminal is close to the second end terminal while the second connection terminal is close to the first end terminal. A first outline of the first sub-bonding pad and a second outline of the second sub-bonding pad are formed as a pair in a complementary manner to construct a configuration of the bonding pad structure.

In the invention, a touch panel includes a plurality of first sensing structures, a plurality of second sensing structures, a plurality of first bonding pad structures, a plurality of second bonding pad structures, and a plurality of wire structures. The first sensing structures respectively have a first terminal opposite to a second terminal. The second sensing structures and the first sensing structures are alternately disposed. Each of the first bonding pad structures includes a first sub-bonding pad and a second sub-bonding pad. A first outline of the first sub-bonding pad and a second outline of the second sub-bonding pad are formed as a pair in a complementary manner to construct a configuration of each of the first bonding pad structures. A first portion and a second portion of the wire structures respectively connect the first sub-bonding pad and the second sub-bonding pad of each of the first bonding pad structures to the first terminal and second terminal of identical or different first sensing structure respectively, and a third portion connects the second bonding pad structure to the second sensing structure.

In the invention, another touch panel includes a substrate, a plurality of sensing structures, a plurality of bonding pad structures, and a plurality of wire structures. The sensing structures are arranged on the substrate, and each of the sensing structures has a first terminal opposite to a second terminal. The bonding pad structure is arranged on the substrate, and each of the bonding pad structures includes a first sub-bonding pad and a second sub-bonding pad; a first outline of the first sub-bonding pad and a second outline of the second sub-bonding pad are formed as a pair in a complementary manner to construct a configuration of each of the bonding pad structures. The wire structures respectively connect the first sub-bonding pad and the second sub-bonding pad of the bonding pad structures to the first terminal and the second terminal of identical or different sensing structures respectively.

In an embodiment of the invention, the width of the first sub-bonding pad of each of the first bonding pad structures gradually decreases toward the first end terminal from the first connection terminal, and the width of the second sub-bonding pad gradually decreases toward the second end terminal from the second connection terminal.

In an embodiment of the invention, each of the first bonding pad structures has an extending direction which points at the second connection terminal from the first connection terminal. In each of the first bonding pad structures, the width variance trend of the first sub-bonding pad along the extending direction is opposite to the width variance trend of the second sub-bonding pad along the extending direction.

In an embodiment of the invention, in each of the first bonding pad structures, the first outline of the first sub-bonding pad and the second outline of the second sub-bonding pad are in point symmetry.

In an embodiment of the invention, the first sub-bonding pad of each of the first bonding pad structures includes a first testing portion adjacent to a first bonding portion. The first connection terminal is an end of the first testing portion away from the first bonding portion, and the first end terminal is an end of the first bonding portion away from the first testing portion. The first sub-bonding pad and the second sub-bonding pad respectively have the first outline and the second outline respectively in L shapes or L-like shapes that are reversely arranged to be complementary to each other. Meanwhile, the second sub-bonding pad of each of the first bonding pad structures includes a second testing portion adjacent to a second bonding portion. The second connection terminal is an end of the second testing portion away from the second bonding portion, and the second end terminal is an end of the second bonding portion away from the second testing portion. The first sub-bonding pad is spaced from the second sub-bonding pad by a gap, and the overall width of the first bonding portion, the gap, and the seconding bonding pad is equivalent to the width of the first testing portion and the second testing portion. In addition, the gap between the first bonding portion and the second bonding portion is in a linear shape, a wave shape, or a bended shape. In an embodiment, the width of the first testing portion is equivalent to the width of the second testing portion.

In an embodiment of the invention, the width of each of the first bonding pad structures is equivalent to the width of each of the second bonding pad structures.

In an embodiment of the invention, the first sub-bonding pad and the second sub-bonding pad respectively have the first outline and the second outline respectively in trapezoidal shapes or trapezoid-like shapes that are reversely arranged to be complementary to each other.

In an embodiment of the invention, the bonding pad structures are in a rectangular shape.

In an embodiment of the invention, the length of each of the first bonding pad structures is equivalent to the length of each of the second bonding pad structures.

In an embodiment of the invention, the wire structures include a plurality of first wires and a plurality of second wires. The first wires are connected between the first terminal of the first sensing structures and the first connecting ten final of the first sub-bonding pad. The second wires are connected between the second terminal of the first sensing structures and the second connecting terminal of the second sub-bonding pad.

In an embodiment of the invention, the touch panel further includes a substrate, wherein the first sensing structures, the second sensing structures, the first bonding pad structures, the second bonding pad structures and the wire structures are disposed on the substrate. Each of the second sensing structures has a third terminal opposite to a fourth terminal. The first portion of the second bonding pad structures is connected to the third terminal. The second portion of the second bonding structures is connected to the fourth terminal. The first bonding pad structures are located between the first portion and the second portion of the second bonding pad structures.

In an embodiment of the invention, the touch panel further includes a intermediate layer, and the intermediate layer has a first side opposite to a second side, wherein the first sensing structures, the first bonding pad structures, and a first portion of the wire structures are disposed at the first side. The second sensing structures, the second bonding pad structures, and a second portion of the wire structures are disposed at the second side. The first portion of the wire structures connects the first sensing structures to the first bonding pad structures, and the second portion of the wire structures connects the second sensing structures to the second bonding pad structures. The intermediate layer is a film substrate or an insulating layer. Here, each of the second bonding pad structures may include a third sub-bonding pad and a fourth sub-bonding pad, wherein the third sub-bonding pad and the fourth sub-bonding pad are separated from each other and respectively connected to a third terminal and a fourth terminal of one of the second sensing structures. The third sub-bonding pad has a third connection terminal opposite to a third end terminal, and the width of the third connection terminal is greater than the width of the third end terminal. The fourth sub-bonding pad has a fourth connection terminal opposite to a fourth end terminal. The width of the fourth connection terminal is greater than the width of the fourth end terminal. The third connection terminal is closer to the fourth end terminal and farther from the fourth connection terminal.

In an embodiment of the invention, the width of the third sub-bonding pad of each of the second bonding pad structures gradually decreases toward the third end terminal from third connection terminal.

In an embodiment of the invention, the width of the fourth sub-bonding pad of each of the second bonding pad structures gradually decreases towards the fourth end terminal from the fourth connection terminal.

In an embodiment of the invention, each of the second bonding pad structures has an extending direction which points at the fourth connection terminal from the third connection terminal. In each of the second bonding pad structures, the width variance trend of the third sub-bonding pad along the extending direction is opposite to the width variance trend of the fourth sub-bonding pad along the extending direction.

In an embodiment of the invention, in each of the second bonding pad structures, the outlines of the third sub-bonding pad and the fourth bonding pad are in point symmetry.

In an embodiment of the invention, the third sub-bonding pad of each of the second bonding pad structures includes a third testing portion adjacent to a third bonding portion, wherein the third connection terminal is an end of the third testing portion away from the third bonding portion, and the third end terminal is an end of the third bonding portion away from the third testing portion.

In an embodiment of the invention, the third sub-bonding pad and the fourth sub-bonding pad are respectively formed to be in an L-like shape or an L shape.

In an embodiment of the invention, the fourth sub-bonding pad of each of the second bonding pad structures includes a fourth testing portion adjacent to a fourth bonding portion, wherein the fourth connection terminal is an end of the fourth testing portion away from the fourth bonding portion, and the fourth end terminal is an end of the fourth bonding portion away from the fourth testing portion. The third sub-bonding pad is spaced from the fourth sub-bonding pad by a gap, and the overall width of the third bonding portion, the gap, and the fourth bonding portion is equivalent to the width of the third testing portion or the fourth testing portion. The gap is in a linear shape, a wave shape, or a bended shape. In addition, the width of the third testing portion is equivalent to the width of the fourth testing portion.

Based on the above, in the embodiments of the invention, the touch panel disposes two bonding pads that are connected to both ends of one sensing structure to be adjacent to each other so as to construct a set of bonding pad structure, and the width variances of the two bonding pads are in an opposite trend. Comparing with the conventional bonding pads that are designed to have a rectangular outline, the set of two bonding pads in the embodiments of the invention may be disposed to be closer, which facilitates to reduce the area for disposing the bonding pads. In addition, the widths of the two bonding pads are not constant so that the wider part of each of the bonding pads provides sufficient area for being in contact with the testing probe to allow the test operation to be conducted easily. To be specific, in the embodiments of the invention, the two bonding pads formed as a set respectively extend towards the other from the widest part, and therefore the two bonding pads have sufficient extending length such that the bonding pads have ideal bonding reliability when being bonded to the circuit board or external components. In the meantime, with the design of the bonding pad in the embodiment of the invention, the bonding pads are disposed to be closer and the area for disposing is further reduced, which helps to reduce the amount of bonding medium (conductive adhesive) used for bonding and the volume thereof. Since the bonding medium may change in volume due to the temperature differences during the manufacturing process, the decrease in the volume of the bonding medium may reduce the possibility of bad reliability caused by such change in volume.

In order to make the aforementioned features and advantages of the invention more comprehensible, embodiments accompanying figures are described in detail below.

### BRIEF DESCRIPTION OF THE DRAWINGS

FIG. 1A is a schematic view illustrating a first embodiment for a bonding pad structure of the invention.

FIG. 1B is a schematic view illustrating a second embodiment for the bonding pad structure of the invention.

FIG. 1C is a schematic view illustrating a third embodiment for the bonding pad structure of the invention.

FIG. 1D is a schematic view illustrating a fourth embodiment for the bonding pad structure of the invention.

FIG. 1E is a schematic view illustrating a fifth embodiment for the bonding pad structure of the invention.

FIG. 2 is a schematic top view illustrating a touch panel according to the first embodiment of the invention.

FIG. 3 is a schematic enlargement view illustrating a portion P in the touch panel according to FIG. 2.

FIG. 4 is a schematic top view illustrating a touch panel according to the second embodiment of the invention.

FIG. 5 is a schematic side view illustrating a touch panel according to the third embodiment of the invention.

FIGS. 6-7 are schematic top views illustrating a first sensing layer and a second sensing layer within the touch panel according to FIG. 5.

FIG. 8 is a schematic side view illustrating a touch panel according to the third embodiment of the invention.

FIG. 9 is a schematic side view illustrating a touch panel according to the fourth embodiment of the invention.

### DESCRIPTION OF EMBODIMENTS

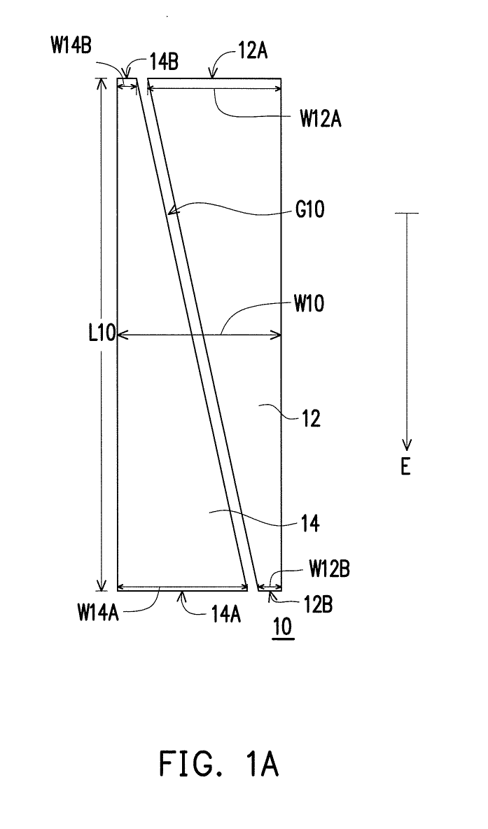

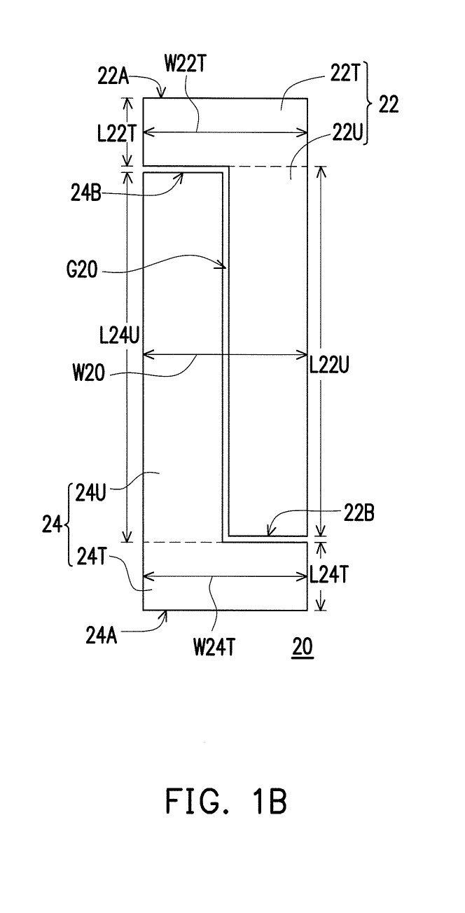

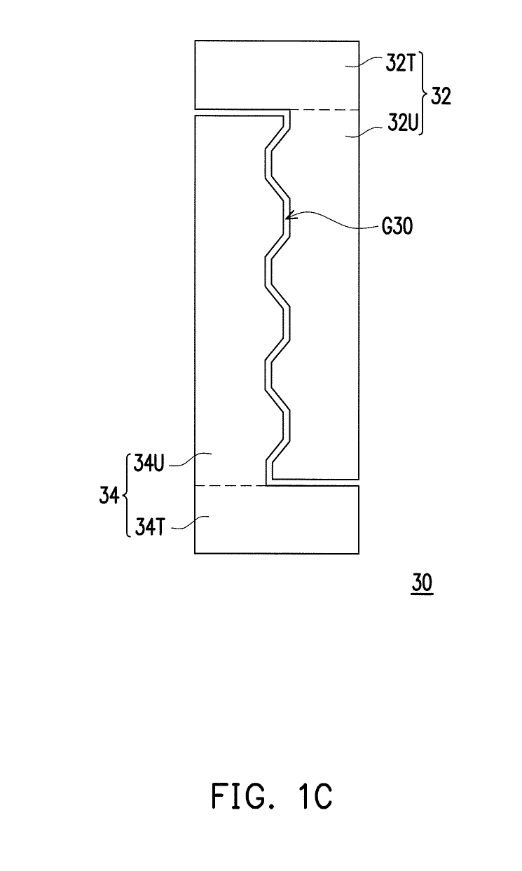

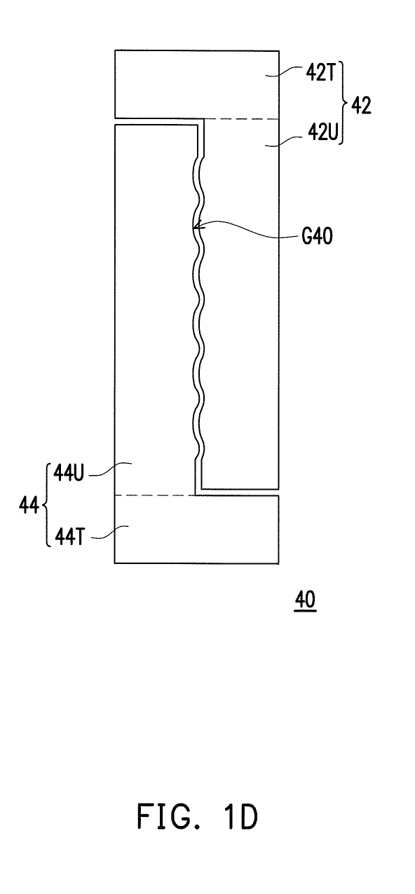

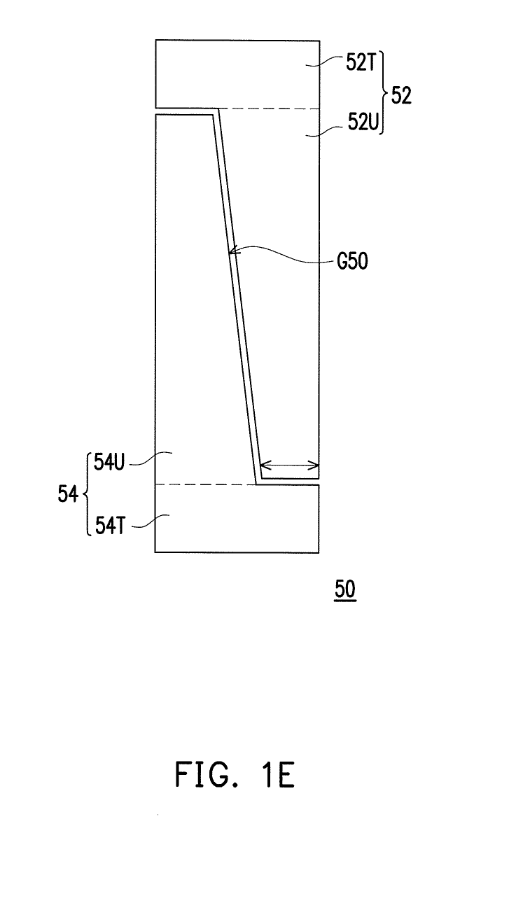

FIG. 1A is a schematic view illustrating a first embodiment for a bonding pad structure of the invention. Please refer to FIG. 1A. A bonding pad structure 10 includes a first sub-bonding pad 12 independent from a second sub-bonding pad 14, and they are spaced from each other by a gap G10. The first sub-bonding pad 12 has a first connection terminal 12A opposite to a first end terminal 12B. A width W12A of the first connection terminal 12A is greater than a width W12B of the first end terminal 12B. The second sub-bonding pad 14 has a second connection terminal 14A opposite to a second end terminal 14B, and a width 14A of the second connection terminal 14A is greater than a width W14B of the second end terminal 14B. In the meantime, the wider first connection terminal 12A is closer to the narrower second end terminal 14B and farther from the wider second connection terminal 14A. When the bonding pad structure 10 is applied in an electronic device as a bonding pad for bonding, the wire in the electronic device is connected to the wider first connection terminal 12A and the second connection terminal 14A.

FIG. 1A shows that the first sub-bonding pad 12 and the second sub-bonding pad 14 in the embodiment have a trapezoid outline. The bonding pad structure 10 is an elongated structure and is defined to have an extending direction E pointing at the second connection terminal 14A from the first connection terminal 12A. The width of the first sub-bonding pad 12 gradually decreases along the extending direction E, and the width of the second sub-bonding pad 14 gradually increases along the extending direction E. That is to say, the width variance trend of the first sub-bonding pad 12 along the extending direction E is opposite to the width variance trend of the second sub-bonding pad 14 along the extending direction E. In addition, an overall width W10 of the bonding pad structure 10 is substantially constant, and therefore the overall first bonding pad structure 10 is in a rectangular shape. In the embodiment, the outline of the first sub-bonding pad 12 and the outline of the second sub-bonding pad 14 may be in point symmetry; therefore, the outlines of the first sub-bonding pad 12 and the second sub-bonding pad 14 are substantially complementary.

The bonding pad structure 10 is bonded to other components. Therefore, the design of the size of the bonding pad structure 10 affects the bonding yield and reliability. When the bonding pad structure 10 is bonded to other components via anisotropic conductive film (ACF) or anisotropic conductive adhesive (ACA), the width W12B and the width W14B may be selectively greater than an average particle size of the conductive particle in the ACF. For example, in the ACF that is applied for bonding the touch panel to the circuit board, the average particle size of the conductive particle is about 10 μm. At the time, the width W12B and the width W14B may be disposed to be selectively greater than 10 μm. In other embodiments, when the average particle size of the conductive particle in the ACF is 3 μm, the width W12B and the width W14B may be disposed to be selectively greater than 3 μm. Accordingly, the width W12B and the width W14B may ensure the bonding reliability. In addition, an overall length L10 of the bonding pad structure 10 may be greater than 1 mm, for example, 1.24 mm or 1.26 mm. In the embodiment, the gap G10 is present to maintain electrical independence of the first sub-bonding pad 12 and the second sub-bonding pad 14, and the width thereof may be determined according to the precision of the manufacturing machine. For example, the gap G10 may be 15 μm to 50 μm or less. The widths W12A and W14A of the first connection terminal 12A and the second connection terminal 14A may be determined according to the size of the probe of the testing machine. In other words, the widths of W12A and W14A have to be sufficient to achieve that the probe with selected size can precisely position and have electronic contact for signal tests.

FIG. 1A shows that the first connection terminal 12A of the first sub-bonding pad 12 of the bonding pad structure 10 has a greater size, and the second connection terminal 14A of the second sub-bonding pad 14 has a greater size. Accordingly, when performing the test, the testing probe may be accurately in contact with the first sub-bonding pad 12 and the second sub-bonding pad 14 so that the test process may be more efficient. Moreover, the lengths of the first sub-bonding pad 12 and the second sub-bonding pad 14 in the extension direction E are substantially equivalent to the overall length L10, which facilitates the ACF to be more reliably and accurately disposed on the bonding pad structure 10. For example, when being disposed on the bonding pad structure 10, if the ACF causes an alignment error in the extending direction E and deviates towards the first connection terminal 12A, the ACF may still be disposed on at least a portion of the second sub-bonding pad 14. Likewise, when being disposed on the bonding pad structure 10, if the ACF causes the alignment error in the extending direction E and deviates towards the second connection terminal 14A, the ACF may still be disposed on at least a portion of the first sub-bonding pad 12. In that case, even if the alignment error occurs during the manufacturing process, the first sub-bonding pad 12 and the second sub-bonding pad 14 may be practically in contact with the ACF, which also ensures that the ACF is reliably disposed on the bonding pad structure 10.

FIG. 1B is a schematic view illustrating a second embodiment for the bonding pad structure of the invention. Please refer to FIG. 1B. A bonding pad structure 20 includes a first sub-bonding pad 22 independent from a second sub-bonding pad 24, and they are spaced from each other by a gap G20. The first sub-bonding pad 22 of the bonding pad structure 20 includes a first testing portion 22T adjacent to a first bonding portion 22U. A first connection terminal 22A is an end of the first testing portion 22T away from the first bonding portion 22U; a first end terminal 22B is an end of the first bonding portion 22U away from the first testing portion 22T. The second sub-bonding pad 24 includes a second testing portion 22T adjacent to a second bonding portion 24U.

The second connection terminal 22A is an end of the second testing portion 22T away from the second bonding portion 22U; the second end terminal 24B is an end of the second bonding portion 22U away from the second testing portion 22T. Here, please refer to FIG. 1A and related descriptions for the design of the sizes of the first connection terminal 22A, the first end terminal 22B, the second connection terminal 22A, and the second end terminal 24B. No further descriptions are incorporated herein.

The first sub-bonding pad 22 and the second sub-bonding pad 24 respectively have outlines that are in an L-like shape or an L shape, and the two outlines are reversely arranged to be complementary to each other. In the embodiment, a width W22T of the first testing portion 22T is equivalent to a width W24T of the second testing portion 24T. Meanwhile, an overall width W20 of the first bonding portion 22U, the gap G20, and the second bonding portion 24U is equivalent to the width W22T of the first testing portion 22T or the width W24T of the second testing portion 24T.

The design for the size of the first testing portion 22T and the second testing portion 24T may be determined according to the requirement of the testing machine. For example, when the probe of the testing machine requires a test area of 0.1 mm, a length L22T of the first testing portion 22T may not be less than 0.1 mm, and a length L24T of the second testing portion 24T may not be less than 0.1 mm. Accordingly, the disposition of the first testing portion 22T and the second testing portion 24T facilitates to enhance test accuracy. The first bonding portion 22U and the second bonding portion 24U are the portions used for being connected to the ACF; therefore, a length L22U of the first bonding portion 22U and a length L24U of the second bonding portion 24U may be determined according to the requirement of the bonding process. For example, in existing bonding processes, the length of the bonding pad is disposed to be 1.24 mm, in the embodiment, the length L22U of the first bonding portion 22U and the length L24U of the second bonding portion 24U may be designed to be 1.24 mm. In addition, the size of the gap G20 may be determined according to the manufacturing precision by referring to the description for the embodiment of FIG. 1A, for example, the size may be 15 μm to 50 μm.

FIG. 1C is a schematic view illustrating a third embodiment for the bonding pad structure of the invention. Please refer to FIG. 1C. A bonding pad structure 30 includes a first sub-bonding pad 32 independent from a second sub-bonding pad 34. The first sub-bonding pad 32 includes a first testing portion 32T and a first bonding portion 32U, and the second sub-bonding pad 34 includes a second testing portion 34T and a second bonding portion 34U. Here, the first testing portion 32T and the first bonding portion 32U are similar to the first testing portion 22T and the first bonding portion 22U of FIG. 1B. The second testing portion 34T and the second bonding portion 34U are similar to the second testing portion 24T and the second bonding portion 24U of FIG. 1B. The two embodiments are different in that a gap G30 between the first bonding portion 32U and the second bonding portion 34U of the embodiment is in a bended shape, whereas the gap G20 between the first bonding portion 22U and the second bonding portion 24U in FIG. 1B is in a linear shape.

FIG. 1D is a schematic view illustrating a fourth embodiment for the bonding pad structure of the invention. Please refer to FIG. 1D. A bonding pad structure 40 includes a first sub-bonding pad 42 independent from a second sub-bonding pad 44. The first sub-bonding pad 42 includes a first testing portion 42T and a first bonding portion 42U. The second sub-bonding pad 44 includes a second testing portion 44T and a second bonding portion 44U. Here, the first testing portion 42T and the first bonding portion 42U are similar to the first testing portion 22T and the first bonding portion 22U of FIG. 1B. The second testing portion 44T and the second bonding portion 44U are similar to the second testing portion 24T and the second bonding portion 24U of FIG. 1B. The two embodiments are different in that a gap G40 between the first bonding portion 42U and the second bonding portion 44U in the embodiment is in a wave shape, whereas the gap G20 between the first bonding portion 22U and the second bonding portion 24U of FIG. 1B is in a linear shape.

FIG. 1E is a schematic view illustrating a fifth embodiment for the bonding pad structure of the invention. Please refer to FIG. 1E. A bonding pad structure 50 includes a first sub-bonding pad 52 independent from a second sub-bonding pad 54. The first sub-bonding pad 52 includes a first testing portion 52T and a first bonding portion 52U. The second sub-bonding pad 54 includes a second testing portion 54T and a second bonding portion 54U. Here, the first testing portion 52T and the first bonding portion 52U are similar to the first testing portion 52T and the first bonding portion 52U of FIG. 1B; the second testing portion 54T and the second bonding portion 54U are similar to the second testing portion 24T and the second bonding portion 24U of FIG. 1B. The two embodiments are different in that a gap G50 between the first bonding portion 52U and the second bonding portion 54U in the embodiment is in an obliquely linear shape, whereas the gap G20 between the first bonding portion 22U and the second bonding portion 24U of FIG. 1B is in a linear shape. In other words, the oblique angles of the gap G50 and the gap G20 are different.

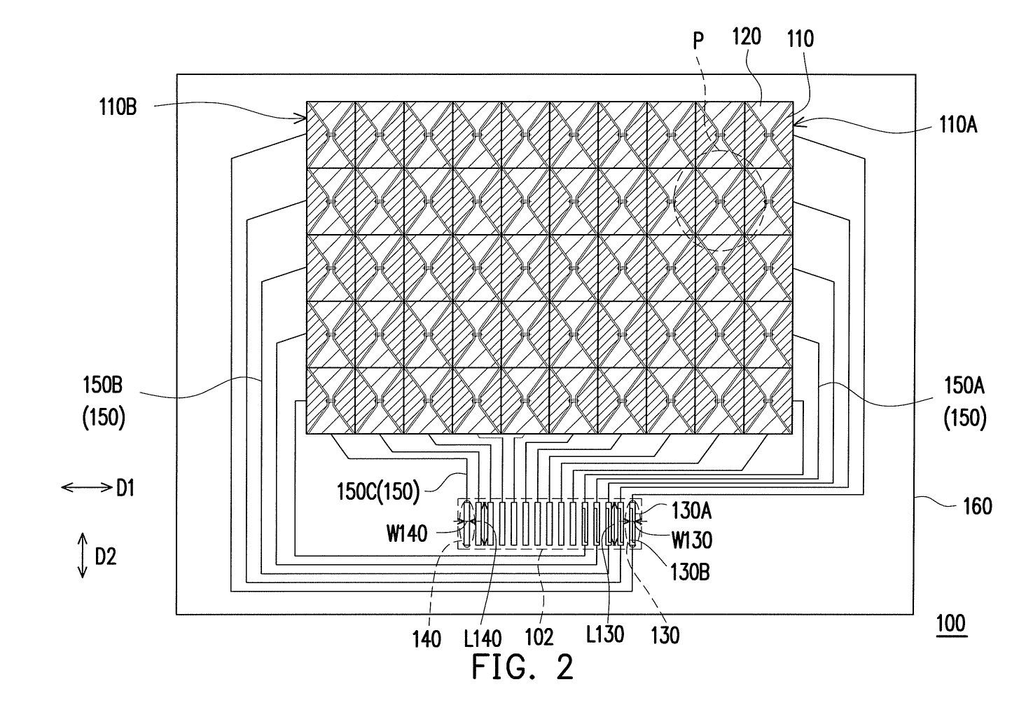

FIG. 2 is a schematic top view illustrating a touch panel according to the first embodiment of the invention. Please refer to FIG. 2. A touch panel 100 includes a plurality of first sensing structures 110, a plurality of second sensing structures 120, a plurality of first bonding pad structures 130, a plurality of second bonding pad structures 140, a plurality of wire structures 150, and a substrate 160, wherein the first sensing structures 110, the second sensing structures 120, the first bonding pad structures 130, the second bonding pad structures 140, and the wire structures 150 are disposed on the substrate 160 and located at the same side of the substrate 160. Take the embodiment as an example, the first sensing structures 110 and the second sensing structures 120 are respectively elongated sensing structures, wherein the extending direction of each of the first sensing structures 110 is a first direction D1, and the extending direction of each of the second sensing structures 120 is a second direction D2, wherein the first direction D1 and the second direction D2 intersect with each other. Therefore, the second sensing structures 120 and the first sensing structures 110 are disposed to intersect with one another. In addition, the first sensing structures 110 and the second sensing structures 120 may be correspondingly connected to the first bonding pad structures 130 and the second bonding pad structures 140 in a bonding pad disposing region 102 via the wire structures 150. Accordingly, a driving control circuit that controls the touch panel 100 may be connected to the first bonding pad structures 130 and the second bonding pad structures 140 so as to perform a touch sensing operation to the first sensing structures 110 and the second sensing structures 120.

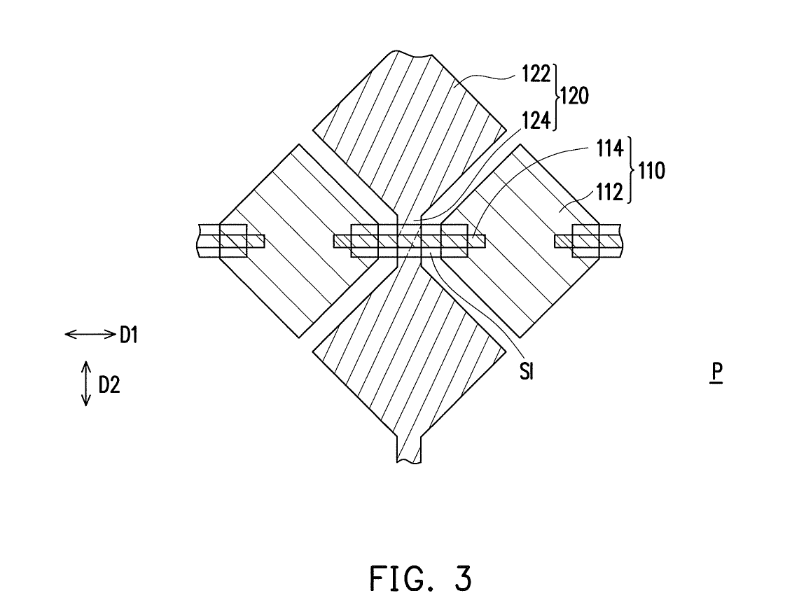

FIG. 3 is a schematic enlargement view illustrating a portion P in the touch panel according to FIG. 2. FIGS. 2-3 show that the first sensing structures 110 include a plurality of diamond-grid shaped first sensing portions 112 and a plurality of first connecting portions 114, wherein each of the first connecting portions 114 connects two adjacent first sensing portions 112 in series in the first direction D1. The second sensing structures 120 include a plurality of diamond-grid shaped second sensing portions 122 and a plurality of second connecting portions 124, wherein each of the second connecting portions 124 connects two adjacent second sensing portions 122 in series in the second direction D2. In the meantime, each of the first connecting portions 114 intersects with a corresponding second connecting portion 124, and an insulating pattern SI is disposed between the connecting portion 114 and the connecting portion 124 so as to avoid short circuit generated therebetween.

Specifically, each of the first bonding pad structures 130 includes a first sub-bonding pad 130A and a second sub-bonding pad 130B, and the first sub-bonding pad 130A and the second sub-bonding pad 130B are separated from each other. Each of the first sensing structures 110 has a first terminal 110A opposite to a second terminal 110B. Meanwhile, the first portion (such as the first wire 150A) of the wire structures 150 connects the first connection terminal of the first sub-bonding pad 130A in the first bonding pad structures 130 to the first terminal 110A of the first sensing structures 110. The second portion (such as the second wire 150B) of the wire structures 150 connects the second terminal of the second sub-bonding pad 130B in the first bonding pad structures 130 to the second terminal 110B of the first sensing structures 110. The third portion (such as the third wire 150C) of the wire structures 150 connects each of the second sensing structures 120 to the corresponding second bonding pad structures 140. In the embodiment, the first bonding pad structures 130 may be realized by selecting any one of the bonding pad structures 10-50 in FIGS. 1A-1E. Therefore, the specific structure design of the first sub-bonding pad 130A and the second sub-bonding pad 130B is not limited to the manner illustrated in FIG. 2.

In the same first bonding pad structure 130, the first sub-bonding pad 130A and the second sub-bonding pad 130B are respectively connected to the first terminal 110A and the second terminal 110B of the same first sensing structures 110 (i.e. so-called “double routing” type). With such configuration, since the first sub-bonding pad 130A and the second sub-bonding pad 130B in the same first bonding pad structure 130 are separated from each other; the first sub-bonding pad 130A, the corresponding first wire 150A, the first sensing structures 110, the corresponding first wire 150B, and the second sub-bonding pad 130B may form a loop, which facilitates the application in electrical tests. However, in other embodiments, in the same first bonding pad structure 130, the first sub-bonding pad 130A and the second sub-bonding pad 130B are respectively connected to the first terminal 110A and the second terminal 110B of two different first sensing structures 110. The wire arrangement in such embodiment is, for example, the first sensing structures 110 at the upper half of the substrate respectively connect the first wire 150B to the second bonding pad 130B from the left-sided second terminal 110B, and the first sensing structures 110 at the lower half of the substrate respectively connect the first wire 150A to the first bonding pad 130A from the right-sided second terminal 110A. Alternatively, the first sensing structures 110 of the odd rows respectively connect the first wire 150B to the second bonding pad 130B from the left-sided second terminal 110B, and the first sensing structures 110 of the even rows respectively connect the first wire 150A to the first bonding pad 130A from the right-sided second terminal 110A, that is, the first sensing structures 110 are routed in a left-right alternate manner from top to bottom.

FIGS. 1A-1E show that the design for the first sub-bonding pad 130A and the second sub-bonding pad 130B allows the overall size of the first bonding structures 130 to be substantially equal to the second bonding pad structures 140. In other words, the width W130 of each of the first bonding pad structures 130 is substantially equal to the width W140 of each of the second bonding pad structures 140, and the length L130 of each of the first bonding pad structures 130 is substantially equal to the length L140 of each of the second bonding pad structures 140. In that case, even though the first bonding pad structures 130 provide two independent sub-bonding pads, the area for the bonding pad disposing region 102 is not significantly increased accordingly. That is to say, the design in the embodiment is that two bonding pads are disposed within the width of a single bonding pad structure so that the bonding pads may be arranged more closely. Since the volume of the bonding medium (such as ACF) in using is related to the area for the bonding pad disposition region 102, the decrease in the area for the bonding pad disposition region 102 helps to reduce the volume of the ACF in using, thereby lowering cost and ensuring the reliability of the ACF. In addition, the descriptions for FIGS. 1A-1E show that the design for the first bonding pad structures 130 helps to enhance test accuracy and also to ensure that the ACF accurately bonds the first sub-bonding pad 130A to the second sub-bonding pad 130B.

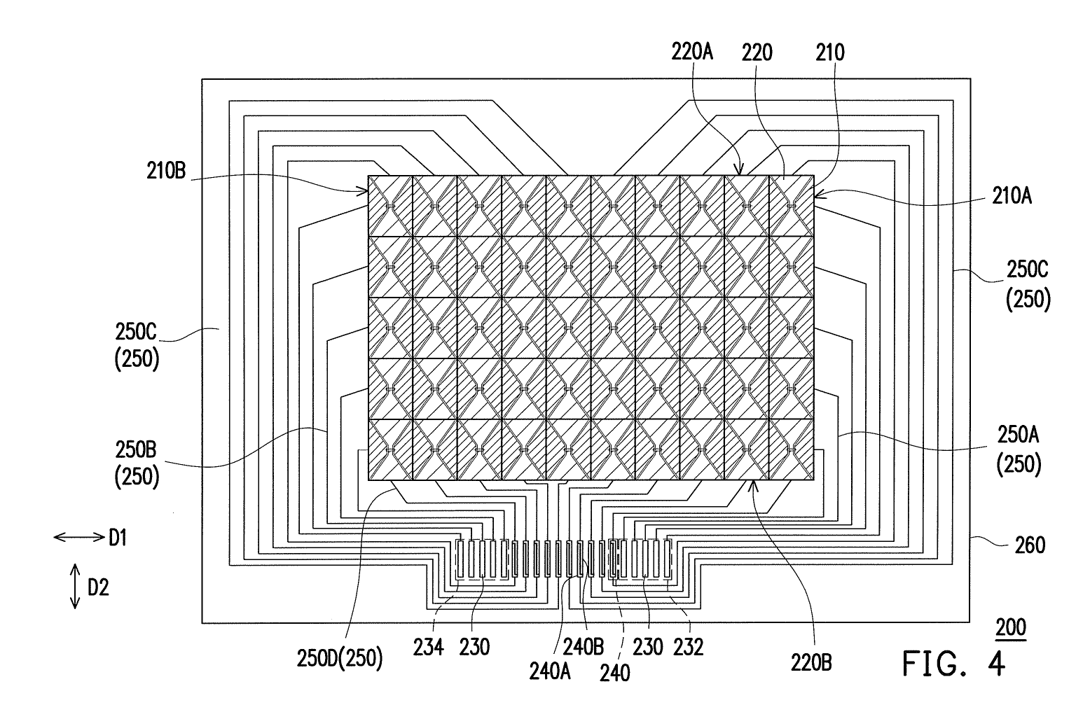

FIG. 4 is a schematic top view illustrating a touch panel according to the second embodiment of the invention. Please refer to FIG. 4. A touch panel 200 includes a plurality of first sensing structures 210, a plurality of second sensing structures 220, a plurality of first bonding pad structures 230, a plurality of second bonding pad structures 240, a plurality of wire structures 250, and a substrate 260, wherein the first sensing structures 210, the second sensing structures 220, the first bonding pad structures 230, the second bonding pad structures 240, and the wire structures 250 are disposed on the substrate 260 and located at the same side of the substrate 260. In the embodiment, the design for the first sensing structures 210 and the second sensing structures 220 is the same as the design for the touch panel 100 in the first embodiment. Therefore, please refer to FIGS. 2-3 for related descriptions. The first bonding pad structures 230 are divided into a first portion 232 and a second portion 234, and the first portion 232 and the second portion 234 are respectively located at two sides of the second bonding pad structures 240. The second bonding pad structures 240 are respectively designed as any one of the bonding pad structures 10-50 in FIGS. 1A-1E. That is to say, the second bonding pad structures 240 respectively include the first sub-bonding pad 240A and the second sub-bonding pad 240B. Besides, the wire structures 250 are divided into a plurality of first wires 250A, a plurality of second wires 250B, a plurality of third wires 250C, and a plurality of fourth wires 250D according to the components connected thereto.

Take the embodiment as an example. A first terminal 210A and a second terminal 210B of each of the first sensing structures 210 are respectively connected to a first bonding pad structure 230, wherein each of the first terminals 210A is connected to one of the first bonding pad structures 230 of the first portion 232 via one of the first wires 250A, and each of the second terminal 210B is connected to one of the first bonding pad structures 230 of the second portion 234 via one of the first wires 250B. Meanwhile, the first terminal 220A and the second terminal 220B of each of the second sensing structures 220 are respectively connected to the first sub-bonding pad 240A and the second sub-bonding pad 240B of the same second bonding pad structures 240, wherein each of the first terminals 220A is connected to the first sub-bonding pad 240A of one of the second bonding pad structures 240 via one of the third wires 250C; each of the second terminals 220B is connected to the second sub-bonding pad 240B of one of the second bonding pad structures 240 via one of the fourth wires 250D. Furthermore, to make the length of the wiring path to be more uniform, a portion of the third wires 250C may pass by the outer side of the first wires 250A, and another portion may pass by the outer side of the second wires 250B.

The descriptions related to FIGS. 1A-1E show that the design for the second bonding pad structures 240 may improve the reliability of the touch panel 200 when being bonded to external components, and also increase the test accuracy of the touch panel 200. Moreover, the design for the second bonding pad structures 240 may allow the bonding pad disposing region of the touch panel 200 to be reduced, facilitating to reduce the amount of bonding medium (such as the ACF) in using and the volume thereof, thereby lowering the cost. In the meantime, the decrease in the volume of the ACF may reduce the possibility of bad reliability caused by the change of the volume of the ACF due to temperature differences during the manufacturing process.

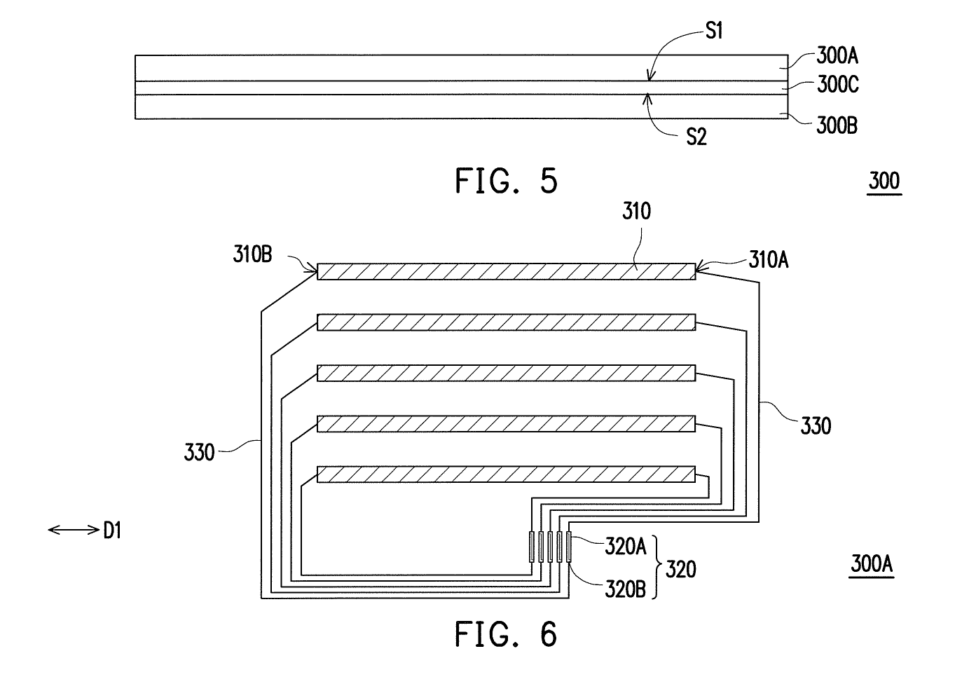

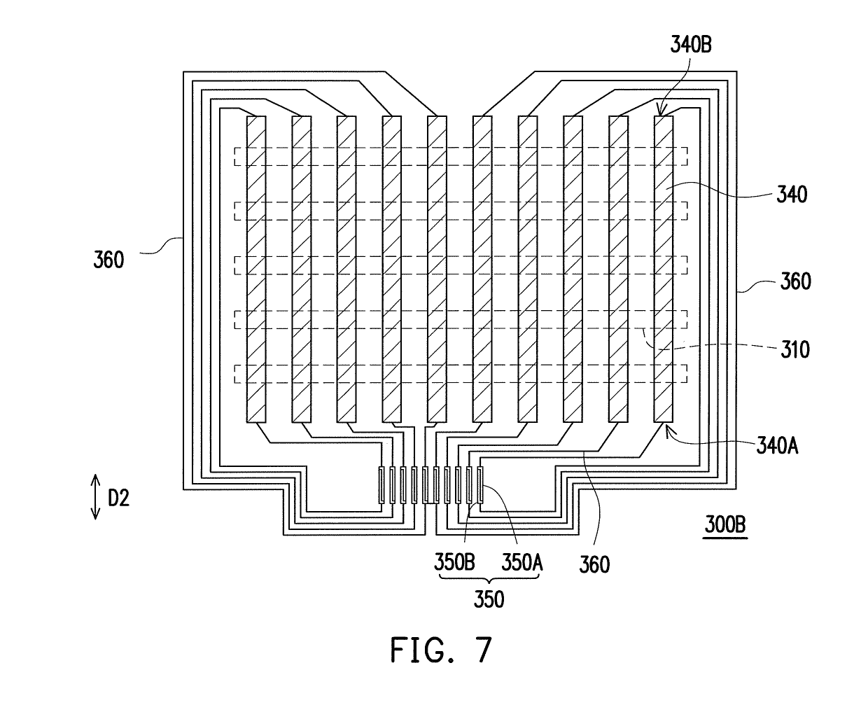

In the touch panel 100 and the touch panel 200, the sensing components are disposed at the same side of the same substrate, and therefore only one of the first bonding pad structure and the second bonding pad structure has the design of the paired bonding pads as illustrated in FIGS. 1A-1E so as to avoid the wire structures to intersect with one another, however, which should not be construed as a limitation to the invention. For example, FIG. 5 is a schematic side view illustrating a touch panel according to the third embodiment of the invention. FIGS. 6-7 are schematic top views illustrating a first sensing layer and a second sensing layer within the touch panel according to FIG. 5. Please refer to FIG. 5 first. A touch panel 300 includes a first sensing layer 300A, a second sensing layer 300B, and a intermediate layer 300C, wherein the intermediate layer 300C is sandwiched between the first sensing layer 300A and the second sensing layer 300B. That is to say, the intermediate layer 300C has a first side S1 opposite to a second side S2, and the first sensing layer 300A and the second sensing layer 300B are respectively disposed at the first side S1 and the second side S2.

Please refer to both FIGS. 5-6. The first sensing layer 300A includes a plurality of first sensing structures 310, first bonding pad structures 320, and a plurality of first wire structures 330, wherein the first sensing structures 310 are elongated conductive patterns respectively extended in a first direction D1. The first bonding pad structures 320 respectively have the design as any one of the bonding pad structures 10-50 illustrated in FIGS. 1A-1E. Therefore, the first bonding pad structures 320 respectively include a first sub-bonding pad 320A and a second sub-bonding pad 320B. Each of the first sub-bonding pads 320A is connected to a first terminal 310A of one of the first sensing structures 310 via one of the first wire structures 330, and each of the second sub-bonding pads 320B is connected to a second terminal 310B of one of the first sensing structures 310 via one of the first wire structures 330. In the meantime, the first terminal 310A and the second terminal 310B of the same first sensing structures 310 are connected to the first sub-bonding pad 320A and the second sub-bonding pad 320B of the same first bonding pad structure 320. Likewise, as the descriptions for FIG. 2 show, in other embodiments, in the same first bonding pad structure 320, the first sub-bonding pad 320A and the second sub-bonding pad 320B are respectively connected to the first terminal 310A and the second terminal 310B of two different first sensing structures 310. In such embodiment, the wire arrangement is, for example, the first sensing structures 310 of the upper half of the substrate respectively connect one of the left-sided first wire structures 310 to the second bonding pad 320B from the left-sided first terminal 310B, and the first sensing structures 310 of the lower half of the substrate respectively connect one of the right-sided first wire structures 330 to the first bonding pad 320A from the right-sided second terminal 310A. Alternatively, the first sensing structures 310 of the odd rows respectively connect one of the left-sided first wire structures 330 to the second bonding pad 320B from the left-sided first terminal 310B, and the first sensing structures 110 of the even rows respectively connect one of the right-sided first wire structures 330 to the first bonding pad 320A from the right-sided second terminal 310A; that is, the first sensing structures 310 are routed in a left-right alternate manner from top to bottom.

Please refer to both FIGS. 5 and 7. The second sensing layer 300B includes a plurality of second sensing structures 340, second bonding pad structures 350, and a plurality of second wire structures 360, wherein the second sensing structures 340 are elongated conductive patterns respectively extended in the second direction D2 and have a third terminal 340A opposite to a fourth terminal 340B. The second bonding pad structures 350 respectively have the design as any one of the bonding pad structures 10-50 as illustrated in FIGS. 1A-1E. Therefore, the second bonding pad structures 350 respectively include a third sub-bonding pad 350A and a fourth sub-bonding pad 350B. Each of the third sub-bonding pads 350A is connected to the third terminal 340A of one of the second sensing structures 340 via one of the second wire structures 360, and each of the fourth sub-bonding pads 350B is connected to the fourth terminal 340B of one of the second sensing structures 340 via one of the second wire structures 360. Besides, the third terminal 340A and the fourth terminal 340B of the same second sensing structure 340 are connected to the third sub-bonding pad 350A and the fourth sub-bonding pad 350B of the same second bonding pad structure 350. Also, in FIG. 7, dash lines represent the outline of the first sensing structure 310 so as to show the relation between the first sensing structure 310 and the second sensing structure 340. It can be obtained that the extending direction (first direction D1) of the first sensing structures 310 intersects with the extending direction (second direction D2) of the second sensing structures 340. In addition, the first sensing structures 310 and the second sensing structures 340 in the embodiment are respectively in an elongated rectangular shape, however, which should not be construed as a limitation to the invention. In other embodiments, the first sensing structures 310 and the second sensing structures 340 may respectively have the diamond-grid series pattern as illustrated in FIG. 2.

FIGS. 5-7 show that the bonding pad structures of the touch panel 300 adopt the designs illustrated in any one of FIGS. 1A-1E, and therefore the bonding pad structures are disposed to be closer, which helps to reduce the area required for disposing the bonding pad structures. Furthermore, in the touch panel 300, the intermediate layer 300C may be a substrate or an insulating layer. When the intermediate layer 300C is a substrate, the first sensing layer 300A and the second sensing layer 300B may be directly disposed at two opposite sides of the substrate, however, which should not be construed as a limitation to the invention.

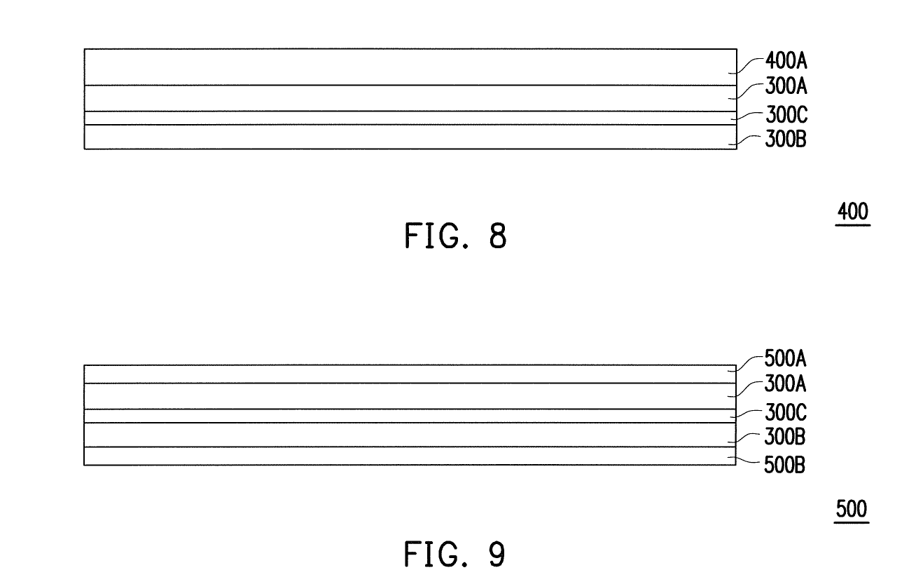

FIG. 8 is a schematic side view illustrating the touch panel according to the third embodiment of the invention. In FIG. 8, a touch panel 400 further includes a substrate 400A apart from the above-mentioned first sensing layer 300A, the second sensing layer 300B, and the intermediate layer 300C; please refer to FIGS. 6-7 and related descriptions in the above embodiments for the specific structures of the first sensing layer 300A, the second sensing layer 300B, and the intermediate layer 300C. In the embodiment, the first sensing layer 300A, the intermediate layer 300C, and the second sensing layer 300B are sequentially disposed on the substrate 400A; that is to say, the intermediate layer 300C is an insulating layer.

FIG. 9 is a schematic side view illustrating a touch panel according to the fourth embodiment of the invention. In FIG. 9, a touch panel 500 further includes a first substrate 500A and a second substrate 500B apart from the above-mentioned first sensing layer 300A, the second sensing layer 300B, and the intermediate layer 300C; please refer to FIGS. 6-7 and related descriptions in the above embodiments for the specific structures of the first sensing layer 300A, the second sensing layer 300B and the intermediate layer 300C. In the embodiment, the first sensing layer 300A is disposed on the first substrate 500A, the second sensing layer 300B is disposed on the second substrate 500B, and the first substrate 500A is adhered to the second substrate 500B via the intermediate layer 300C. That is to say, the intermediate layer 300C is an insulating adhesive layer. Moreover, the first sensing layer 300A and the second sensing layer 300B are located between the first substrate 500A and the second substrate 500B, however, which should not be construed as a limitation to the invention. In other embodiments, the first sensing layer 300A and the first substrate 500A may be upside down so that the first substrate 500A is disposed between the first sensing layer 300A and the intermediate layer 300C.

The touch panels in each of the above embodiments are exemplified to be provided with the first sensing structures intersecting with the second sensing structures on the same layer of the same substrate, or provided with the first sensing layer and the second sensing layer that are respectively arranged on different layers of the same substrate or on different substrates. As a matter of fact, the design of the bonding pad structures disclosed in the invention may also be applied in a single-layered touch panel with a single sensing structure provided with only one of the first sensing structure or the second sensing structure on the substrate.

To sum up, in the embodiments of the invention, the touch panel makes two sub-bonding pads that are connected to the same sensing structure to be a pair and complementary in shape so that the two paired sub-bonding pads that are complementary in shape have opposite width variance trends, and the overall size of the two sub-bonding pads is about to be equal to the size of a single independent bonding pad. Accordingly, the bonding pads are disposed to be closer and the bonding pad disposing region is further reduced, facilitating to reduce the amount of the bonding medium (such as the ACF) in using and the disposing volume. Meanwhile, the widths of each of the sub-bonding pads are not constant, wherein the wider region of the sub-bonding pads may provide sufficient area for the test operation to be carried out easily. Altogether, the touch panel in the embodiments of the invention may reduce the area for the bonding pad disposition, save the cost for the bonding medium, mitigate the problem caused by the bonding medium, and also maintain the accuracy of test operations.

It will be apparent to those skilled in the art that various modifications and variations can be made to the structure of the disclosed embodiments without departing from the scope or spirit of the invention. In view of the foregoing, it is intended that the disclosure cover modifications and variations of this specification provided they fall within the scope of the following claims and their equivalents.

What is claimed is:

1. A bonding pad structure, comprising:
a first sub-bonding pad, having a first connection terminal and a first end terminal respectively located at two opposite ends, a width of the first connection terminal being greater than a width of the first end terminal; and
a second sub-bonding pad, close to but separated from the first sub-bonding pad, and the second sub-bonding pad having a second connection terminal and a second end terminal respectively located at two opposite ends, a width of the second connection terminal being greater than a width of the second end terminal, wherein the first connection terminal is close to the second end terminal, and the second connection terminal is close to the first end terminal;
wherein a first outline of the first sub-bonding pad and a second outline of the second sub-bonding pad are formed as a pair in a complementary manner to construct a configuration of the bonding pad structure.

2. The bonding pad structure according to claim 1, wherein the width of the first sub-bonding pad gradually decreases toward the first end terminal from the first connection terminal, and the width of the second sub-bonding pad gradually decreases toward the second end terminal from the second connection terminal.

3. The bonding pad structure according to claim 1, wherein each of the bonding pad structures has an extending direction pointing at the second connection terminal from the first connection terminal, in each of the bonding pad structures, a width variance trend of the first sub-bonding pad in the extending direction is opposite to a width variance trend of the second sub-bonding pad in the extending direction.

4. The bonding pad structure according to claim 1, wherein the first outline of the first sub-bonding pad and the second outline of the second sub-bonding pad are in point symmetry.

5. The bonding pad structure according to claim 1, wherein:
the first sub-bonding pad comprises a first testing portion adjacent to a first bonding portion, the first connection terminal is an end of the first testing portion away from the first bonding portion, and the first end terminal is an end of the first bonding portion away from the first testing portion; the second sub-bonding portion comprises a second testing portion adjacent to a second bonding portion, the second connection terminal is an end of the second testing portion away from the second bonding portion, and the second end terminal is an end of the second bonding portion away from the second testing portion.

6. The bonding pad structure according to claim 5, wherein the first sub-bonding pad is spaced from the second sub-bonding pad by a gap, and an overall width of the first bonding portion, the gap, and the second bonding portion is equal to a width of the first testing portion or the second testing portion.

7. The bonding pad structure according to claim 6, wherein the gap between the first bonding portion and the second bonding portion is in a linear shape, a wave shape, or a bended shape.

8. The bonding pad structure according to claim 5, wherein a width of the first testing portion is equal to a width of the second testing portion.

9. The bonding pad structure according to claim 1, wherein the first sub-bonding pad and the second sub-bonding pad respectively have the first outline and the second outline respectively in L shapes or L-like shapes that are reversely arranged to be complementary to each other.

10. The bonding pad structure according to claim 1, wherein the first sub-bonding pad and the second sub-bonding pad respectively have the first outline and the second outline respectively in trapezoidal shapes or trapezoid-like shapes that are reversely arranged to be complementary to each other.

11. The bonding pad structure according to claim 1, wherein the configuration of the bonding pad structure is in a rectangular shape.

12. A touch panel, comprising:
a plurality of first sensing structures respectively having a first terminal opposite to a second terminal;
a plurality of second sensing structures disposed to intersect with the first sensing structures;
a plurality of first bonding pad structures, each of the first bonding pad structures comprising a first sub-bonding pad and a second sub-bonding pad, and a first outline of the first sub-bonding pad and a second outline of the second sub-bonding pad are formed as a pair in a complementary manner to construct a configuration of each of the first bonding pad structures;
a plurality of second bonding pad structures; and
a plurality of wire structures, a first portion and a second portion of the wire structures respectively connecting the first sub-bonding pad and the second sub-bonding pad of each of the first bonding pad structures to the first terminal and the second terminal of an identical first sensing structure or different first sensing structures, and a third portion of the wire structures connecting the second bonding pad structures to the second sensing structures.

13. The touch panel according to claim 12, wherein:
the first sub-bonding pad comprises a first connection terminal and a first end terminal respectively located at two opposite ends, and a width of the first connection terminal is greater than a width of the first end terminal; and
the second sub-bonding pad is close to but separated from the first sub-bonding pad, and the second sub-bonding pad comprises a second connection terminal and a second end terminal respectively located at two opposite ends, and a width of the second connection terminal is greater than a width of the second end terminal, wherein the first connection terminal is close to the second end terminal, and the second connection terminal is close to the first end terminal.

14. The touch panel according to claim 13, wherein the first portion of the wire structures comprises a plurality of first wires and the second portion of the wire structures comprises a plurality of second wires, the first wires are connected between the first terminals of the first sensing structures and the first connection terminals of the first sub-bonding pads, and the second wires are connected between the second terminals of the first sensing structures and the second connection terminals of the second sub-bonding pads.

15. The touch panel according to claim 13, wherein the second sensing structures respectively have a third terminal opposite to a fourth terminal, each of the second bonding pad structures comprises a third sub-bonding pad and a fourth sub-bonding pad, a third outline of the third sub-bonding pad and a fourth outline of the fourth sub-bonding pad are formed as a pair in a complementary manner to construct a configuration of each of the second bonding pad structures.

16. The touch panel according to claim 15, wherein the third sub-bonding pad is close to but separated from the fourth sub-bonding pad and respectively connected to the third terminal and the fourth terminal of one of the second sensing structures or different second sensing structures, wherein the third sub-bonding pad has a third connection terminal and a third end terminal respectively located at two opposite ends, a width of the third connection terminal is greater than a width of the third end terminal, the fourth sub-bonding pad has a fourth connection terminal and a fourth end terminal respectively located at two opposite ends, a width of the fourth connection terminal is greater than a width of the fourth end terminal, and the third connection terminal is close to the fourth end terminal, and the fourth connection terminal is close to the third end terminal.

17. The touch panel according to claim 12, wherein a width of each of the first bonding pad structures is equal to a width of each of the second bonding pad structures.

18. The touch panel according to claim 12, wherein a length of each of the first bonding pad structures is equal to a length of each of the second bonding pad structures.

19. The touch panel according to claim 12, further comprising a substrate, wherein the first sensing structures, the second sensing structures, the first bonding pad structures, the second bonding pad structures, and the wire structures are disposed on the substrate.

20. The touch panel according to claim 12, wherein the first bonding pad structures are adjacent to the second bonding pad structures and arranged to be parallel in a row.

21. The touch panel according to claim 12, further comprising an intermediate layer having a first side opposite to a second side, the first sensing structures, the first bonding pad structures, and the first portion of the wire structures are disposed at the first side, and the second sensing structures, the second bonding pad structures, and the second portion of the wire structures are disposed at the second side.

22. The touch panel according to claim 12, wherein the first sensing structures are disposed on a first substrate, the second sensing structures are disposed on a second substrate, and the first substrate and the second substrate are adhered together via an intermediate layer.

23. A touch panel, comprising:
a substrate;
a plurality of sensing structures arranged on the substrate, each of the sensing structures having a first terminal opposite to a second terminal;
a plurality of bonding pad structures arranged on the substrate, each of the bonding pad structures comprising a first sub-bonding pad and a second sub-bonding pad, and a first outline of the first sub-bonding pad and a second outline of the second sub-bonding pad formed as a pair in a complementary manner to construct a configuration of each of the bonding pad structures; and
a plurality of wire structures respectively connecting the first sub-bonding pad and the second sub-bonding pad of the bonding pad structures to the first terminal and the second terminal of the identical or different sensing structure.

24. The touch panel according to claim 23, wherein:
the first sub-bonding pad has a first connection terminal and a first end terminal respectively located at two opposite ends, a width of the first connection terminal is greater than a width of the first end terminal; and
the second sub-bonding pad is close to but separated from the first sub-bonding pad, and the second sub-bonding pad has a second connection terminal and a second end terminal respectively located at two opposite ends, a width of the second connection terminal is greater than a width of the second end terminal, wherein the first connection terminal is close to the second end terminal, and the second connection terminal is close to the first end terminal.

25. The bonding pad structure according to claim 24, wherein a width of the first sub-bonding pad gradually decreases towards the first end terminal from the first connection terminal, and a width of the second sub-bonding pad gradually decreases towards the second end terminal from the second connection terminal.

26. The bonding pad structure according to claim 24, wherein each of the bonding pads structures has an extending direction pointing at the second connection terminal from the first connection terminal, in each of the bonding pad structures, a width variance trend of the first sub-bonding pad in the extending direction is opposite to a width variance trend of the second sub-bonding pad in the extending direction.

27. The bonding pad structure according to claim 24, wherein:
the first sub-bonding pad comprises a first testing portion adjacent to a first bonding portion, the first connection terminal is an end of the first testing portion away from the first bonding portion, and the first end terminal is an end of the first bonding portion away from the first testing portion; the second sub-bonding pad comprises a second testing portion adjacent to a second bonding portion, the second connection terminal is an end of the second testing portion away from the second bonding portion, and the second end terminal is an end of the second bonding portion away from the second testing portion.

28. The bonding structure according to claim 27, wherein the first sub-bonding pad is spaced from the second sub-bonding pad by a gap, and an overall width of the first bonding portion, the gap, and the second bonding portion is equal to a width of the first testing portion or the second testing portion.

29. The bonding pad structure according to claim 28, wherein the gap between the first bonding portion and the second bonding portion is in a linear shape, a wave shape, or a bended shape.

30. The bonding pad structure according to claim 27, wherein a width of the first testing portion is equal to a width of the second testing portion.

31. The bonding pad structure according to claim 23, wherein the first outline of the first sub-bonding pad and the second outline of the second sub-bonding pad are in point symmetry.

32. The bonding pad structure according to claim 23, wherein the first sub-bonding pad and the second sub-bonding pad respectively have the first outline and the second outline in L shapes or L-like shapes that are reversely arranged to be complementary to each other.

33. The bonding pad structure according to claim 23, wherein the first sub-bonding pad and the second sub-bonding pad respectively have the first outline and the second outline respectively in trapezoidal shapes or trapezoidal-like shapes that are reversely arranged to be complementary to each other.
